(19) United States
(12) Patent Application Publication
(10) Pub. No.: US 2008/0118816 A1
(43) Pub. Date: May 22, 2008

(54) STACK FOR DIRECT OXIDATION FUEL CELL, AND DIRECT OXIDATION FUEL CELL INCLUDING THE SAME

(76) Inventors: Chan Kwak, Yongin-si (KR); Alexey Alexandrovichserov, Yongin-si (KR); Chang-Bong Lee, Yongin-si (KR); Si-Hyun Lee, Yongin-si (KR)

Correspondence Address: CHRISTIE, PARKER & HALE, LLP, PO BOX 7068, PASADENA, CA, 91109-7068, US

(21) Appl. No.: 11/696,700

(22) Filed: Apr. 4, 2007

(30) Foreign Application Priority Data
Apr. 28, 2006 (KR) 10-2006-0038796

(51) Int. Cl. H01M 4/92; H01M 4/90; H01M 8/10

(52) U.S. Cl. 429/40; 429/44; 429/30; 429/32

(57) ABSTRACT

A stack for a direct oxidation fuel cell and a direct oxidation fuel cell system including the stack are provided. The stack for a direct oxidation fuel cell includes at least one membrane-electrode assembly including an anode and a cathode facing each other and a polymer electrolyte membrane interposed between the anode and cathode, and separators disposed at both sides of the membrane-electrode assembly. The cathode includes a platinum-based catalyst and a selective catalyst that can be active for reduction of an oxidant. The stack for a direct oxidation fuel cell of the present invention can have improved performance by including the platinum-based catalyst and the selective catalyst in a cathode catalyst layer, thereby minimizing catalyst poisoning due to a crossed-over fuel and maximizing catalyst activity for reduction of an oxidant.

### CROSS-REFERENCE TO RELATED APPLICATION

This application claims priority to and the benefit of Korean Patent Application No. 10-2006-0038796 filed in the Korean Intellectual Property Office on Apr. 28, 2006, the entire content of which is incorporated herein by reference.

### BACKGROUND OF THE INVENTION

1. Field of the Invention

The present invention relates to a stack for a direct oxidation fuel cell and a direct oxidation fuel cell system including the same.

2. Description of the Related Art

A fuel cell is a power generation system for producing electrical energy through an electrochemical redox reaction of an oxidant and hydrogen in a hydrocarbon-based material such as methanol, ethanol, or natural gas.

Such a fuel cell is a clean energy source that can replace fossil fuels. It includes a stack composed of unit cells and produces various ranges of power output. Since it has a four to ten times higher energy density than a small lithium battery, and it has been highlighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell, which uses methanol as a fuel.

The polymer electrolyte fuel cell has advantages of high energy density and high power, but it also has problems in the need to carefully handle hydrogen gas and the requirement of accessory facilities such as a fuel reforming processor for reforming methane or methanol, natural gas, and the like in order to produce hydrogen as the fuel gas.

On the contrary, a direct oxidation fuel cell has a lower energy density than that of the polymer electrolyte fuel cell, but it has the advantages of easy handling of a fuel, being capable of operating at room temperature due to its low operation temperature, and no need for additional fuel reforming processors.

In the above fuel cell, the stack that generates electricity substantially includes several to many unit cells stacked in multiple layers, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to the anode and adsorbed on catalysts of the anode, and the fuel is oxidized to produce protons and electrons. The electrons are transferred into the cathode via an external circuit, and the protons are also transferred into the cathode through the polymer electrolyte membrane. In addition, an oxidant is supplied to the cathode, and then the oxidant, protons, and electrons are reacted on catalysts of the cathode to produce electricity along with water.

### SUMMARY OF THE INVENTION

An exemplary embodiment of the present invention provides a stack for a direct oxidation fuel cell that can minimize catalyst poisoning due to a crossed-over fuel, and thereby maximize catalyst activity for reduction of an oxidant.

Another embodiment of the present invention provides a direct oxidation fuel cell system including the stack for a direct oxidation fuel cell.

According to one embodiment, a stack for a direct oxidation fuel cell is provided including at least one membrane-electrode assembly including an anode and a cathode facing each other and a polymer electrolyte membrane interposed therebetween, and a separator positioned at both sides of the membrane-electrode assembly. The anode and the cathode each include an electrode substrate and a catalyst layer disposed on the electrode substrate. The cathode catalyst layer may include a platinum-based catalyst and a selective catalyst having selectivity for reduction of an oxidant.

The selective catalyst includes a carrier and an active material supported on the carrier. The active material may be selected from the group consisting of an M-N-based compound, where M is a metal selected from the group consisting of Fe, Co, Ni, Cu, and combinations thereof, a Ru—Ch-based compound, where Ch is an element selected from the group consisting of S, Se, Te, and combinations thereof, and combinations thereof.

The active material can be selected from the group consisting of Fe—N, Co—N, RuSe, and combinations thereof.

The platinum-based catalyst may be selected from the group consisting of platinum, ruthenium, osmium, a platinum-ruthenium alloy, a platinum-osmium alloy, a platinum-palladium alloy, a platinum-M′ alloy, and combinations thereof, where M′ is a transition element selected from the group consisting of Ga, Ti, V, Cr, Mn, Fe, Co, Ni, Cu, Zn, Sn, Mo, W, Rh, Ru, and combinations thereof.

In an embodiment, the cathode catalyst layer is disposed corresponding to a fuel inlet and may include a first area including a selective catalyst and a second area including a platinum-based catalyst.

In another embodiment, the cathode catalyst layer is disposed corresponding to a fuel inlet as aforementioned and may further include a third area positioned between the first and second areas and including both a selective catalyst and a platinum-based catalyst.

In one embodiment, when the catalyst layer includes a platinum-based catalyst, its concentration gradient may increase from a fuel inlet of a separator to a fuel outlet thereof.

In another embodiment, when the catalyst layer includes a selective catalyst, its concentration gradient may decreases from a fuel inlet of a separator to a fuel outlet thereof.

According to another embodiment, a direct oxidation fuel cell system is provided including the stack, a fuel supplier for supplying an electricity generating element with a fuel, and an oxidant supplier for supplying the electricity generating element with an oxidant.

### BRIEF DESCRIPTION OF THE DRAWINGS

FIG. 1 schematically shows a decomposed perspective view of a stack according to one embodiment of the present invention.

FIG. 2 schematically shows a cross-sectional view of a cathode catalyst layer according to another embodiment of the present invention.

FIG. 3 schematically shows a structure of a fuel cell system according to yet another embodiment of the present invention.

### DETAILED DESCRIPTION OF THE EMBODIMENTS

A fuel cell in general generates electricity through oxidation of a fuel and reduction of an oxidant. The fuel cell is representatively classified into a polymer electrolyte fuel cell and a direct oxidation fuel cell. The direct oxidation fuel cell generates electricity by directly oxidizing a hydrocarbon-based fuel such as methanol, ethanol, and the like at an anode and reducing an oxidant at a cathode.

However, the direct oxidation fuel cell has a fuel cross-over problem. The cross-over problem is a phenomenon where a fuel at an anode flows into a cathode through a polymer electrolyte membrane. The crossed-over fuel poisons a catalyst at the cathode, deteriorating catalyst activity for reduction of an oxidant.

In particular, platinum, which has the biggest activity for reduction of an oxidant, tends to be easily poisoned by a crossed-over fuel, sharply deteriorating catalyst activity. In addition, a fuel cross-over tends to increase in proportion to the fuel concentration. Accordingly, when platinum is used as the catalyst, a fuel with a high concentration cannot be used.

Unlike platinum, RuSe can be selectively active for reduction of an oxidant (hereinafter, referred to as a “selective catalyst”), and therefore may be used as an alternative catalyst that can replace platinum. However, the selective catalyst has much lower activity than platinum.

In order to solve this problem, a stack of the present invention is designed to have a cathode catalyst layer including both a selective catalyst, which can be selectively active for reduction of an oxidant, and a platinum-based catalyst, and thereby, the cathode catalyst layer may have maximized performance.

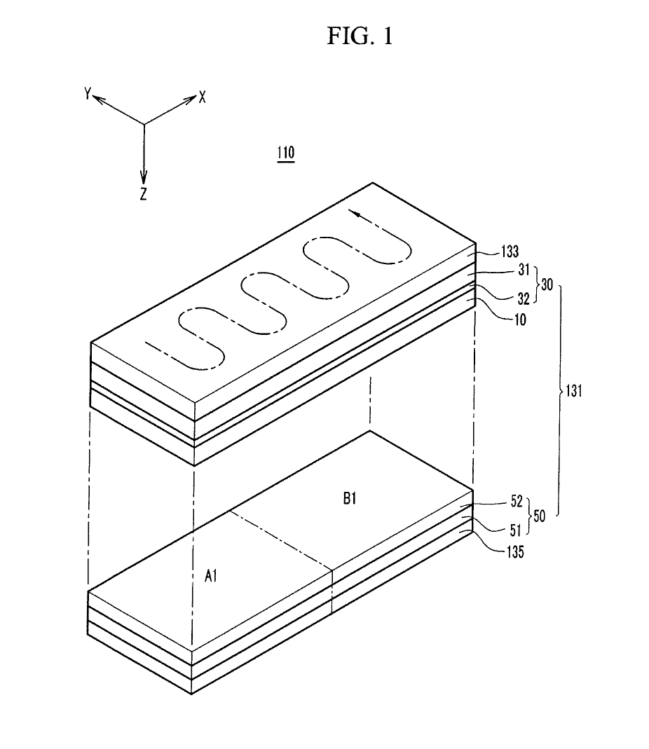

FIG. 1 schematically shows a perspective view of a stack 110 according to one embodiment of the present invention.

The stack 110 includes at least one membrane-electrode assembly 131 and separators 133 and 135 disposed at both sides of the membrane-electrode assembly 131.

The separators 133 and 135 play the role of a conductor connecting an anode 30 and a cathode 50 in series, as well as a role of a supporter. They may include a flow channel (not shown) on their surface, through which an oxidant and a fuel for a reaction of the fuel cell can be supplied to the anode 30 and the cathode 50 of the membrane-electrode assembly 131.

The separators 133 and 135 may include metal, graphite, a carbon-resin composite, or the like. The metal may include stainless steel, aluminum, titanium, copper, or an alloy thereof. The carbon-resin composite may include a composite of a resin selected from the group consisting of an epoxy-based resin, an ester-based resin, a vinyl ester-based resin, a urea resin, and combinations thereof, and a carbon such as graphite and the like. However, the separators 133 and 135 of the present invention are not limited thereto.

The separators 133 and 135 are disposed at both sides of the membrane-electrode assembly 131. The membrane-electrode assembly 131 includes the anode 30 and the cathode 50 facing each other and a polymer electrolyte membrane 10 interposed between the anode 30 and the cathode 50. The anode 30 and the cathode 50 respectively include catalyst layers 32 and 52 and electrode substrates 31 and 51 supporting the catalyst layers 32 and 52.

The cathode catalyst layer 52 includes a platinum-based catalyst and a selective catalyst that can be selectively active for reduction of an oxidant.

The platinum-based catalyst promotes an oxidant reduction reaction at a cathode and may include at least one selected from the group consisting of platinum, ruthenium, osmium, platinum-ruthenium alloys, platinum-osmium alloys, platinum-palladium alloys, platinum-M′ alloys, and combinations thereof, wherein M′ is a transition element selected from the group consisting of Ga, Ti, V, Cr, Mn, Fe, Co, Ni, Cu, Zn, Sn, Mo, W, Rh, Ru, and combinations thereof. More specifically, non-limiting examples of the platinum-based catalyst are selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/RuN, Pt/Fe/Co, Pt/Ru/Rh/Ni, Pt/Ru/Sn/W, and combinations thereof.

Such a platinum-based catalyst may be used in a form of a metal itself (black catalyst), or one supported on a carrier. Non-limiting examples of the carrier may include a carbon-based material such as graphite, denka black, ketjen black, acetylene black, carbon nanotube, carbon nanofiber, carbon nanowire, and carbon nanoballs, an inorganic material particulate such as activated carbon, or alumina, silica, titania, zirconia, and so on. However, a carbon-based material is generally used.

The selective catalyst can be selectively active only for reduction of an oxidant.

In one embodiment, the selective catalyst may include a carrier and an active material supported on the carrier. The active material may be selected from the group consisting of an M-N-based compound where M is a metal selected from the group consisting of Fe, Co, Ni, Cu, and combinations thereof, a Ru—Ch-based compound where Ch is an element selected from the group consisting of S, Se, Te, and combinations thereof, and combinations thereof.

In one embodiment, the active material may be selected from the group consisting of Fe—N, Co—N, RuSe, and combinations thereof. According to another embodiment of the present invention, it may include RuSe.

The carrier may include a carbon-based material, in particular, graphite, denka black, ketjen black, acetylene black, carbon nanotube, carbon nanofiber, carbon nanowire, carbon nanoball, activated carbon, or the like.

As mentioned above, the cathode catalyst layer 52 of the present invention includes a platinum-based catalyst and a selective catalyst that can be selectively active for reduction of an oxidant and thereby is not effected by a crossed-over fuel and can still activate reduction of an oxidant, even when a fuel passes through the polymer electrolyte membrane 10 and flows into the cathode catalyst layer 52 non-activating the platinum-based catalyst.

In addition, in a case where a fuel does not cross over the polymer electrolyte membrane 10, the platinum-based catalyst can be highly active for reduction of an oxidant, improving performance of the cathode 50.

The selective catalyst and the platinum-based catalyst can be included in the cathode catalyst layer 52 in various ways.

According to one embodiment of the present invention, the selective catalyst and the platinum-based catalyst can be mixed and coated all over a cathode catalyst layer 52.

However, according to another embodiment of the present invention, since a fuel cross-over does not occur uniformly at the cathode catalyst layer 52, the cathode catalyst layer 52 can be partly coated with a selective catalyst and a platinum-based catalyst. In one embodiment, the cathode catalyst layer 52 can be divided into two parts as shown in FIG. 1, and a selective catalyst is coated on a first area (A1) having relatively more fuel cross-over and disposed corresponding to a fuel inlet of a separator, and a platinum-based catalyst is coated on a second area (B1) having less fuel cross-over and disposed corresponding to a fuel outlet of a separator.

Referring to FIG. 1, an arrow shows an imaginary line through which a fuel flows along a channel of the separator 133. When the fuel flows along the channel of the separator 133, it becomes diffused into an electrode substrate 31 of the anode 30 neighboring the channel, and thereby is transferred to the catalyst layer 32 of the anode 30. Accordingly, the fuel may be absorbed the most where it first contacts with the electrode 31, and then the fuel becomes less absorbed as it moves farther along the channel. In other words, the fuel is less absorbed in the electrode substrate 31 and the catalyst layer 32 of the anode 30 as it goes farther along an x direction in FIG. 1. Accordingly, the fuel crosses over the polymer electrolyte membrane 10 less as it goes farther along the x direction.

In other words, the fuel is more absorbed in area A1 of the catalyst layer 52 of the cathode 50 than in area B1 thereof. Accordingly, the area A1 may include a selective catalyst having excellent anti-poisoning characteristics against the fuel to decrease non-activation of the catalyst by a crossed-over fuel, while the area B1 may include a platinum-based catalyst having high activity, improving battery performance.

In one embodiment, since the fuel tends to cross-over less along an x direction, a boundary between the areas A1 and B1 may include a mixed catalyst of a platinum-based catalyst and a selective catalyst rather than only one of other of them to provide further improved effects.

Likewise, according to still another embodiment of the present invention, a catalyst layer 52 of a cathode 50 can be divided into three areas rather than two. A first area having high fuel cross-over and disposed corresponding to an inlet of a separator 133 may be coated with a selective catalyst, a second area having low fuel cross-over and disposed corresponding to an outlet of the separator 133 may be coated with a platinum-based catalyst, and a third area between the first and second areas can include a mixture of the selective catalyst and the platinum-based catalyst.

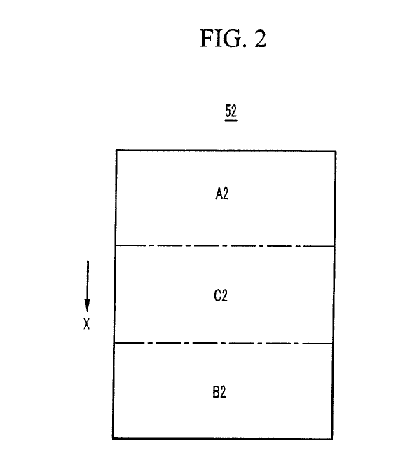

FIG. 2 schematically shows a cross-sectional view of a catalyst layer 52 of a cathode 50 according to another embodiment of the present invention. As shown in FIG. 2, the catalyst layer 52 is divided into three areas. A first area (A2) of the catalyst layer 52, having the most fuel cross-over and disposed corresponding to an inlet of a separator (not shown), is coated with only a selective catalyst, a second area (B2), having the least cross-over and disposed corresponding to an outlet, is coated with only a platinum-based catalyst, and a third area (C2), disposed in the middle of the first and second areas, may be coated with both a platinum-based catalyst and a selective catalyst.

Furthermore, the cathode catalyst layer 52 can be divided into four, five, or more areas. The more cross-over occurs in the area, the more the area may include a selective catalyst, appropriately mixed with a platinum-based catalyst.

In addition, when a cathode catalyst layer 52 is divided into several areas, a selective catalyst may not be discontinuously included but rather the amount thereof may be gradually reduced from an inlet area of a separator having high cross-over to an outlet area having low cross-over, that is, along an x direction of FIG. 1, while the amount of a platinum-based catalyst is gradually increased.

In FIGS. 1 and 2, the imaginary lines respectively distinguishing the areas A1 and B1 and A2, B2, and C2 show how a catalyst layer of a cathode can be imaginarily divided. The size of the areas for a selective catalyst and a platinum-based catalyst, and the boundaries thereof, may be variously regulated considering the flow channel structure of a separator.

How the platinum-based catalyst and the selective catalyst are included in a cathode catalyst layer 52 is based on the fuel flow shown in FIG. 1. When a separator has a different flow structure, the way that the platinum-based catalyst and the selective catalyst are included in the cathode catalyst layer 52 can also be appropriately modified.

In addition, an anode 30 in a membrane-electrode assembly 131 is where oxidation of a fuel occurs, and a catalyst layer 32 of the anode 30 may include a platinum-based catalyst as conventionally used. The platinum-based catalyst may include at least one selected from the group consisting of platinum, ruthenium, osmium, platinum-ruthenium alloys, platinum-osmium alloys, platinum-palladium alloys, platinum-M′ alloys, and combinations thereof, where M′ is a transition element selected from the group consisting of Ga, Ti, V, Cr, Mn, Fe, Co, Ni, Cu, Zn, Sn, Mo, W, Rh, Ru, and combinations thereof. In a direct oxidation fuel cell, an anode may include a platinum-ruthenium alloy catalyst, so that the platinum-ruthenium alloy catalyst can effectivley prevent catalyst poisoning due to CO generated at the anode. More specifically, non-limiting examples of the platinum-based catalyst are selected from the group consisting of Pt, Pt/Ru, Pt/Ru, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

Such a metal catalyst may be used in a form of a metal itself (black catalyst), or one supported on a carrier. The carrier may include a carbon-based material such as graphite, denka black, ketjen black, acetylene black, carbon nanotube, carbon nanofiber, carbon nanowire, and carbon nanoballs, an inorganic material particulate such as activated carbon, or alumina, silica, titania, zirconia, and so on. However, a carbon-based material is generally used.

The catalyst layers 32 and 52 of the anode and the cathode may include a binder resin to improve adherence and proton transfer properties.

The binder resin may be a proton conductive polymer resin having a cation exchange group at its side chain selected from the group consisting of a sulfonic acid group, a carboxylic acid group, a phosphoric acid group, a phosphonic acid group, and derivatives thereof. Non-limiting examples of the polymer include at least one proton conductive polymer selected from the group consisting of perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The binder resins may be used singularly or in combination. They may be used along with non-conductive polymers to improve adherence with the polymer electrolyte membrane. The binder resins may be used in a controlled amount to adapt to their purposes.

Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, and combinations thereof.

The catalyst layers 32 and 52 of the anode 30 and the cathode 50 are supported by the electrode substrates 31 and 51, respectively.

The electrode substrates 31 and 51 respectively support the anode 30 and the cathode 50 and provide paths for transferring a fuel and an oxidant to the catalyst layers 32 and 52 thereof. As for the electrode substrates 31 and 51, a conductive substrate is used, for example, a carbon paper, a carbon cloth, a carbon felt, or a metal cloth (a porous film including a metal cloth fiber or a metalized polymer fiber) but is not limited thereto.

The electrode substrates 31 and 51 may be treated with a fluorine-based resin to be water-repellent to prevent deterioration of diffusion efficiency due to water generated during operation of a fuel cell. The fluorine-based resin may include polytetrafluoroethylene, polyvinylidene fluoride, polyhexafluoro propylene, polyperfluoroalkylvinylether, polyperfluoro sulfonylfluoride alkoxyvinyl ether, fluorinated ethylene propylene, polychlorotrifluoro ethylene, or copolymers thereof, but is not limited thereto.

A microporous layer (MPL, not shown) can be added between the aforementioned electrode substrates 31 and 51 and the catalyst layers 33 and 53 to increase reactant diffusion effects. The microporous layer generally includes conductive powders with a particular particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include, but is not limited to, polytetrafluoro ethylene, polyvinylidene fluoride, polyhexafluoro propylene, polyperfluoroalkylvinyl ether, polyperfluoro sulfonylfluoride alkoxy vinyl ether, polyvinyl alcohol, cellulose acetate, or copolymers thereof. The solvent may include, but is not limited to, an alcohol such as ethanol, isopropyl alcohol, n-propyl alcohol, butanol, and so on, water, dimethyl acetamide, dimethyl sulfoxide, N-methylpyrrolidone, and tetrahydrofuran. The coating method may include, but is not limited to, screen printing, spray coating, doctor blade methods, gravure coating, dip coating, silk screening, painting, and so on, depending on the viscosity of the composition.

A polymer electrolyte membrane 10 is positioned between the anode 30 and the cathode 50.

The polymer electrolyte membrane 10 plays a role of exchanging ions by transferring protons produced at the anode catalyst layer 32 to the cathode catalyst layer 52. The proton conductive polymer for the polymer electrolyte membrane 10 of the present invention may be any polymer resin having proton conductivity. Examples of the proton conductive polymer are a polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin include at least one proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The H can be replaced with Na, K, Li, Cs, or tetrabutylammonium in a proton conductive group of the proton conductive polymer. When the H is substituted by Na in an ion exchange group at the terminal end of the proton conductive group, NaOH is used, when the H is replaced with tetrabutylammonium, tributylammonium hydroxide is used, and K, Li, or Cs can also be replaced by using appropriate compounds. A method of substituting H is known in this related art, and therefore is not further described in detail.

Since the aforementioned stack 110 of the present invention has excellent selectivity for reduction of an oxidant, it can be effectively used in a direct oxidation fuel cell having a fuel cross-over problem. It can be more effectively used in a direct methanol fuel cell (DMFC) using methanol in a high concentration as a fuel.

According to another embodiment of the present invention, a direct fuel cell system including the above stack is provided.

The fuel cell system of the present invention includes a stack, a fuel supplier, and an oxidant supplier.

The stack plays a role of generating electricity through oxidation of a fuel and reduction of an oxidant and is the same as aforementioned.

The fuel supplier plays a role of supplying the stack with a fuel including hydrogen, and the oxidant supplier plays a role of supplying the stack with an oxidant. The oxidant includes oxygen or air.

The fuel includes liquid or gaseous hydrogen, or a hydrocarbon-based fuel such as methanol, ethanol, propanol, butanol, or natural gas. The fuel has no particular limit to its concentration but can be used in a high concentration of more than 3M. According to another embodiment of the present invention, it can be used in a concentration of 3 to 15M, and according to still another embodiment of the present invention, it can be used in a concentration of 3 to 5M.

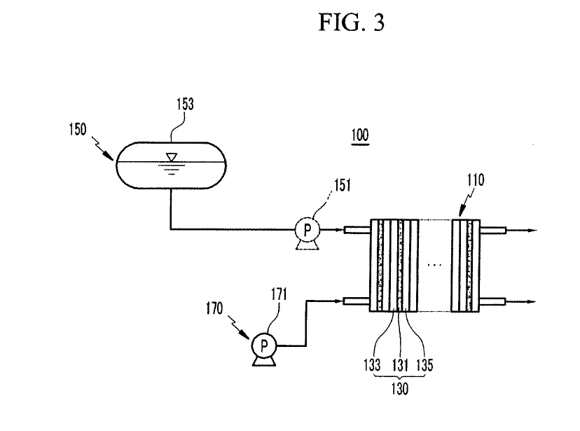

FIG. 3 shows a schematic structure of a fuel cell system 100 that will be described in detail with reference to this accompanying drawing as follows. FIG. 3 illustrates a fuel cell system wherein a fuel and an oxidant are provided to the electricity generating element 130 through pumps 151 and 171, but the present invention is not limited to such a structure. The fuel cell system of the present invention alternatively may include a structure wherein a fuel and an oxidant are provided in a diffusion manner.

The fuel cell system 100 includes a stack 110 composed of at least one electricity generating element 130 that generates electrical energy through an electrochemical reaction of a fuel and an oxidant, a fuel supplier 150 for supplying the fuel to the electricity generating element 130, and an oxidant supplier 170 for supplying the oxidant to the electricity generating element 130.

In addition, the fuel supplier 150 is equipped with a tank 153, which stores fuel, and the fuel pump 151, which is connected therewith. The fuel pump 151 supplies fuel stored in the tank 153 with pumping power.

The oxidant supplier 170, which supplies the electricity generating element 130 of the stack 110 with the oxidant, is equipped with at least one pump 171 for supplying the oxidant with pumping power.

The electricity generating element 130 includes a membrane-electrode assembly 131, which oxidizes hydrogen or a fuel and reduces an oxidant, and separators 133 and 135 that are respectively positioned at opposite sides of the membrane-electrode assembly and supply hydrogen or a fuel, and an oxidant, respectively. At least one electricity generating element 130 constitutes a stack 110.

The following examples illustrate the present invention in more detail. However, it is understood that the present invention is not limited by these examples.

### Example 1

0.35 g of RuSe/C and 2.08 g of a 5 wt %-polyperfluorosulfonate binder were mixed with 7.3 ml of a solvent of isopropyl alcohol and water mixed in a ratio of 1:9 to prepare a catalyst slurry. The catalyst slurry was coated on a first area of an electrode substrate formed of carbon paper. On the other hand, another slurry was prepared by mixing 0.35 g of PVC, 2.08 g of a 5 wt %-NAFION™ solution, and 7.3 ml of a solvent of isopropyl alcohol and water mixed in a ratio of 1:9. The catalyst slurry was coated on a second area of the carbon paper electrode substrate, preparing a cathode for a fuel cell. Herein, the first and second areas had an area ratio of 3:7.

Next, a catalyst slurry for an anode was prepared by mixing platinum-ruthenium black, a polyperfluorosulfonate binder, and a mixed solvent of isopropyl alcohol and water. The catalyst slurry was coated on a carbon paper electrode substrate to prepare an anode for a fuel cell.

The anode and the cathode for a fuel cell were respectively positioned on a NAFION (perfluorosulfonic acid) polymer electrolyte membrane, and then hot-pressed at 135° C. with a pressure of 200 kgf/cm² for 3 minutes, forming a cathode and an anode on the polymer electrolyte membrane.

Next, a membrane-electrode assembly was fabricated by positioning the cathode and the anode at both sides of a polymer electrolyte membrane and settling them.

The membrane/electrode assembly was interposed between glass fiber gaskets coated with polytetrafluoroethylene, and then compressed between copper end plates, preparing a stack.

The stack was connected to a fuel supplier and an oxidant supplier, fabricating a fuel cell system.

### Example 2

A fuel cell system was fabricated according to Example 1 except that the first and second areas in the catalyst layer of the cathode were regulated to have an area ratio of 5:5.

### COMPARATIVE EXAMPLE 1

A fuel cell system was fabricated according to Example 1 except that platinum was coated on both the first and second areas, fabricating a membrane electrode assembly (MEA).

### COMPARATIVE EXAMPLE 2

A fuel cell system was fabricated according to Example 1 except that RuSe/C was coated on both the first and second areas, fabricating a membrane electrode assembly (MEA).

For the fuel cell systems prepared according to Example 1 and Comparative Examples 1 and 2, the anode was supplied with a methanol solution in 1M concentration, and the cathode was supplied with dry air. Then, the fuel cell systems were operated at 70° C. for 10 hours, and thereafter estimated regarding power density.

Judging from the results, the fuel cell system of Example 1 had higher power density than Comparative Examples 1 and 2. Accordingly, the fuel cell system of Example 1 including a stack according to the present invention can be predicted to have better catalyst activity for reduction of an oxidant in a cathode catalyst layer than Comparative Examples 1 and 2.

The fuel cell system of Example 2 was also estimated regarding the power density in the same method as aforementioned except for using a methanol solution in 3M concentration.

As a result, the fuel cell system of Example 2 had the same power density as that of Example 1, even though it had the possibility of cross-over due to the use of a fuel in a high concentration. The reason is that both a platinum-based catalyst and a selective catalyst are included in the optimal position of a cathode catalyst layer, and thereby, catalyst poisoning due to the fuel is decreased, securing excellent catalyst activity.

Therefore, a stack for a direct oxidation fuel cell of the present invention includes a platinum-based catalyst and a selective catalyst in a catalyst layer of a cathode electrode, and can thereby minimize catalyst poisoning due to a fuel and maximize catalyst activity for reduction of an oxidant, improving performance of a direct oxidation fuel cell system including the stack.

While this invention has been described in connection with what are considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stack for a direct oxidation fuel cell comprising:
at least one membrane-electrode assembly comprising an anode and a cathode facing each other and a polymer electrolyte membrane interposed therebetween, wherein the anode and the cathode each comprise an electrode substrate and a catalyst layer on the electrode, and the cathode catalyst layer comprises a platinum-based catalyst, and a selective catalyst that can be selectively active for reduction of an oxidant; and
a separator positioned at both sides of the membrane-electrode assembly.

2. The stack of claim 1, wherein the selective catalyst comprises:
a carrier and an active material supported on the carrier and selected from the group consisting of an M-N-based compound, where M is a metal selected from the group consisting of Fe, Co, Ni, Cu, and combinations thereof, a Ru—Ch-based compound, where Ch is an element selected from the group consisting of S, Se, Te, and combinations thereof, and combinations thereof.

3. The stack of claim 2, wherein the active material is selected from the group consisting of Fe—N, Co—N, RuSe, and combinations thereof.

4. The stack of claim 2, wherein the active material comprises RuSe.

5. The stack of claim 2, wherein the carrier is a carbon-based material selected from the group consisting of graphite, denka black, ketjen black, acetylene black, carbon nanotubes, carbon nanofiber, carbon nanowire, carbon nanoballs, activated carbon, and combinations thereof.

6. The stack of claim 1, wherein the platinum-based catalyst is selected from the group consisting of platinum, ruthenium, osmium, a platinum-ruthenium alloy, a platinum-osmium alloy, a platinum-palladium alloy, a platinum-M′ alloy, and combinations thereof, where M′ is a transition element selected from the group consisting of Ga, Ti, V, Cr, Mn, Fe, Co, Ni, Cu, Zn, Sn, Mo, W, Rh, Ru, and combinations thereof.

7. The stack of claim 1, wherein the platinum-based catalyst is supported on a carrier selected from the group consisting of a carbon-based material, an inorganic material particulate, and combinations thereof.

8. The stack of claim 1, wherein the cathode catalyst layer comprises:
a first area positioned corresponding to a fuel inlet of a separator and comprising a selective catalyst; and
a second area disposed corresponding to a fuel outlet of the separator and comprising a platinum-based catalyst.

9. The stack of claim 1, wherein the cathode catalyst layer comprises:
a first area positioned corresponding to a fuel inlet of a separator and comprising a selective catalyst;
a second area disposed corresponding to a fuel outlet of the separator and comprising a platinum-based catalyst; and
a third area positioned between the first and second areas and comprising a selective catalyst and a platinum-based catalyst.

10. The stack of claim 1, wherein the catalyst layer comprises a platinum-based catalyst having an increasing concentration gradient from a fuel inlet of a separator toward a fuel outlet thereof.

11. The stack of claim 1, wherein the catalyst layer comprises a selective catalyst having a decreasing concentration gradient from a fuel inlet of a separator toward a fuel outlet thereof.

12. The stack of claim 1, wherein the anode is selected from the group consisting of platinum, ruthenium, osmium, a platinum-ruthenium alloy, a platinum-osmium alloy, a platinum-palladium alloy, a platinum-M′ alloy, and combinations thereof, where M′ is a transition element of Ga, Ti, V, Cr, Mn, Fe, Co, Ni, Cu, Zn, Sn, Mo, W, Rh, Ru, and combinations thereof.

13. The stack of claim 1, wherein the electrode substrate is selected from the group consisting of carbon paper, carbon cloth, carbon felt, metal cloth (a porous film formed of metal fiber cloth or a metal film coated on polymer fiber, that is to say, a metalized polymer fiber), and combinations thereof.

14. The stack of claim 1, wherein the polymer electrolyte membrane comprises a polymer resin having a cation exchange group at its side chain selected from the group consisting of a sulfonic acid group, a carboxylic acid group, a phosphoric acid group, a phosphonic acid group, and derivatives thereof.

15. The stack of claim 14, wherein the polymer resin is selected from the group consisting of a fluoro-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, a polyphenylquinoxaline-based polymer, and co-polymers thereof.

16. A direct oxidation fuel cell system comprising:
an electricity generating element comprising
a stack comprising
at least one a membrane-electrode assembly comprising an anode and a cathode facing each other and a polymer electrolyte membrane interposed between the anode and the cathode, wherein the anode and the cathode each comprise an electrode substrate and a catalyst layer on the electrode substrate, and the catalyst layer of the cathode comprises a platinum-based catalyst and a selective catalyst that can be selectively active for reduction of an oxidant;
separators disposed at both sides of the membrane-electrode assembly;
a fuel supplier adapted to supply the electricity generating element with a fuel; and
an oxidant adapted to supply the electricity generating element with an oxidant.

17. The direct oxidation fuel cell system of claim 16, wherein the selective catalyst comprises a carrier, and an active material supported on the carrier and selected from the group consisting of an M-N-based compound, where M is a metal selected from the group consisting of Fe, Co, Ni, Cu, and combinations thereof, a Ru—Ch-based compound, where Ch is an element selected from the group consisting of S, Se, Te, and combinations thereof, and combinations thereof.

18. The direct oxidation fuel cell system of claim 17, wherein the active material is selected from the group consisting of Fe—N, Co—N, RuSe, and combinations thereof.

19. The direct oxidation fuel cell system of claim 17, wherein the active material is RuSe.

20. The direct oxidation fuel cell system of claim 17, wherein the carrier is a carbon-based material selected from the group consisting of graphite, denka black, ketjen black, acetylene black, carbon nanotubes, carbon nanofiber, carbon nanowire, carbon nanoballs, activated carbon, and combinations thereof.

21. The direct oxidation fuel cell system of claim 16, wherein the platinum-based catalyst is selected from the group consisting of platinum, ruthenium, osmium, a platinum-ruthenium alloy, a platinum-osmium alloy, a platinum-palladium alloy, a platinum-M′ alloy, and combinations thereof, where M′ is a transition element selected from the group consisting of Ga, Ti, V, Cr, Mn, Fe, Co, Ni, Cu, Zn, Sn, Mo, W, Rh, Ru, and combinations thereof.

22. The direct oxidation fuel cell system of claim 16, wherein the platinum-based catalyst is supported on a carrier comprising a carbon-based material, an inorganic material particulate, and combinations thereof.

23. The direct oxidation fuel cell system of claim 16, wherein the cathode catalyst comprises:
a first area disposed corresponding to an inlet of a separator and comprising a selective catalyst; and
a second area disposed corresponding to an outlet of a separator and comprising a platinum-based catalyst.

24. The direct oxidation fuel cell system of claim 16, wherein the cathode catalyst comprises:
a first area disposed corresponding to an inlet of a separator and comprising a selective catalyst;
a second area disposed corresponding to an outlet of a separator and comprising a platinum-based catalyst; and
a third area positioned between the first and second areas and comprising both a selective catalyst and a platinum-based catalyst.

25. The direct oxidation fuel cell system of claim 16, wherein the catalyst layer comprises a platinum-based catalyst in an increasing concentration gradient from an inlet of a separator to an outlet thereof.

26. The direct oxidation fuel cell system of claim 16, wherein the catalyst layer comprises a selective catalyst in a decreasing concentration gradient from an inlet of a separator to an outlet thereof.

27. The direct oxidation fuel cell system of claim 16, wherein the anode comprises a catalyst selected from the group consisting of platinum, ruthenium, osmium, a platinum-ruthenium alloy, a platinum-osmium alloy, a platinum-palladium alloy, a platinum-M′ alloy, and combinations thereof, where M′ is a transition element selected from the group consisting of Ga, Ti, V, Cr, Mn, Fe, Co, Ni, Cu, Zn, Sn, Mo, W, Rh, Ru, and combinations thereof.

28. The direct oxidation fuel cell fuel cell system of claim 16, wherein the fuel has a concentration of more than 3M.

29. The direct oxidation fuel cell fuel cell system of claim 16, wherein the fuel has a concentration ranging from 3 to 15M.

30. The direct oxidation fuel cell system of claim 16, wherein the fuel cell is a direct methanol fuel cell.
